(19) United States
(12) Patent Application Publication
(10) Pub. No.: US 2023/0359442 A1
(43) Pub. Date: Nov. 9, 2023

(54) CODE CONTEXT ASSEMBLY

(71) Applicant: Microsoft Technology Licensing, LLC, Redmond, WA (US)

(72) Inventors: Albert ZIEGLER, Uppsala (SE); Oegerikus DE MOOR, Tas-Sliema (MT); Johan Sebastian Heesemann ROSENKILDE, Birkerod (DK); Edward Emil AFTANDILIAN, Sunnyvale, CA (US); Max SCHAEFER, Kidlington (GB)

(21) Appl. No.: 17/740,164

(22) Filed: May 9, 2022

(51) Int. Cl. G06F 8/33; G06F 8/41

(52) U.S. Cl. CPC G06F 8/33; G06F 8/427

(57) ABSTRACT

A computer system is configured to identify a position of a cursor in an editor where a code file is displayed and identify one or more wish items based on the position of the cursor or metadata associated with the code file. The computer system is further configured to identify one or more first portions of text from the one or more wish items that are relevant to text immediately preceding the cursor, and prioritize the one or more first portions of text to identify a particular first portion of text that is most relevant to the text immediately preceding the cursor. The computer system then generates a second portion of text based on the particular first portion of text and suggest that the second portion of text be entered at the cursor.

### BACKGROUND

Existing language models may be trained based on a corpus of input text, and then these language models can be used to predict how a given input text will continue. While historically being used for natural language modeling, language modeling technologies have been extended to code language modeling. Using code language modeling, the content of a source code file that appear prior to an input cursor are used as input to the code language model, in order to predict how the source code file should continue after the cursor.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The embodiments described herein are related to a computer system. The computer system is configured to identify a position of a cursor in an editor where a code file is displayed. The computer system is also configured to identify one or more wish items based on the position of the cursor and/or metadata associated with the code file. The one or more wish items include at least one of (1) text prior to the cursor, (2) text after the cursor, (3) text from an open tab of the editor, (4) text in a second code file that is stored at a location that is relevant to the code file, and/or (5) metadata associated with the code file. In some embodiments, the metadata associated with the code file includes path information associated with where the code file is stored, or a programming language in which the code file is written.

The computer system is further configured to identify one or more first portions of text from the one or more wish items that are relevant to text immediately preceding the cursor, and prioritize the one or more first portions of text to identify a particular first portion of text in the one or more first portions that are most relevant to a portion of text that is immediately preceding the cursor. Based on the particular first portion of text, the computer system then generates a second portion of text, and suggests that the second portion of text be entered preceding the cursor. In some embodiments, generating the second portion of text is based on a code language model.

In some embodiments, the wish items include (1) text immediately preceding the cursor, and (2) text immediately following the cursor. The computer system is further configured to identify a tree structure based on the portion of text immediately preceding the cursor, and the text immediately following the cursor. The computer system is further configured to identify a first object immediately preceding the cursor, and identify one or more second objects immediately following the cursor that are siblings to the first object in the tree structure. The one or more second objects are then moved in front of the first object to generate a modified tree structure with the cursor at an end of the tree. The second portion of text is then generated based on the modified tree structure, and the second portion of text is suggested to be entered preceding the cursor.

In some embodiments, the one or more wish items include text from one or more open tabs of the editor. The computer system is configured to compare the portion of text immediately preceding the cursor with a rolling window of text in the one or more open tabs of the editor to determine a similarity score. The computer system is also configured to identify a portion of text in the rolling window that has a highest similarity score with the portion of text immediately preceding the cursor, and generate the second portion of text based on the portion of text in the rolling window. The same process may be performed for a second code file that is stored at a location that is relevant to the code file to identify a portion of text in the second code file that has a highest similarity score with the portion of text immediately preceding the cursor, and generate the second portion of text based on the portion of text in the second code file that has the highest similarity score.

The principles described herein are also related to a method for generating context at a cursor in an editor where a code file is displayed. The method includes identifying a position of the cursor, and identifying one or more wish items based on the position of the cursor or metadata associated with the code file. The one or more wish items include at least one of (1) text prior to the cursor, (2) text after the cursor, (3) text from an open tab of the editor, (4) text in a second code file that is stored at a location that is relevant to the code file, and/or (5) metadata associated with the code file.

The method further includes identifying one or more first portions of text from the one or more wish items that are relevant to a portion of text immediately preceding the cursor, and prioritizing the one or more first portions of text to identify a particular second portion of text in the one or more second portions that are most relevant to the portion of text immediately preceding the cursor. The method further includes generating a second portion of text based on the particular second portion of text and suggesting that the second portion of text be entered preceding the cursor.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not, therefore, to be considered to be limiting in scope, embodiments will be described and explained with additional specificity and details through the use of the accompanying drawings in which:

FIG. 1 illustrates an example code context assembly that implements the principles described herein;

FIG. 2 illustrates an example user interface of a code editor or a development environment (DE) that implements the principles described herein;

FIG. 3 illustrates another example user interface of a code editor or a DE that implements the principles described herein;

FIG. 4 illustrates an example of a tree structure that is identified by parsing a portion of text immediately preceding the cursor and a portion of text immediately following the cursor of FIG. 3;

FIG. 5 illustrates an example process of moving one or more siblings of objects in front of an object that is immediately preceding a cursor;

FIG. 6 illustrates another example user interface of a code editor or a DE that implements the principles described herein;

FIG. 7 illustrates another example user interface of a code editor or a DE that implements the principles described herein;

FIG. 8 illustrates an example process of identifying snippets of code in an open tab or another file that are relevant to a portion of text immediately preceding a cursor of a current file;

FIG. 9 illustrates an example process of identifying a particular file in a plurality of files that is the most similar to the current file that is being edited;

FIG. 10 illustrates a flowchart of an example method for generating context based on a wishlist of wish items;

FIG. 11 illustrates a flowchart of an example method for generating a portion of text based on one or more sibling objects of an object immediately preceding a cursor, where the one or more sibling objects may be entered before or after the cursor; and

FIG. 12 illustrates an example computer system in which the principles described herein may be employed.

### DETAILED DESCRIPTION

Presently, code language models are trained to use, as an input prompt, lines of code before an editor cursor to the language model, and to generate a prediction for the continuation merely based on the code before the cursor. The inventors recognize that programmers often do not merely write code from top to bottom. Additionally, the inventors recognize that programmers often work on related files simultaneously, or keep related files open in different editor tabs. However, presently, the code after an editor cursor or in the other related files is not used as an input prompt to existing code language models and thus the usefulness of the predictions by those models is limited.

The current application discloses a code context assembly that not only considers text before an editor cursor for use as an input prompt, but also considers text after the editor cursor, text in neighboring editor tabs, text in other code files stored in a relevant folder, and/or metadata associated with the code file.

In embodiments, a language model is limited by a size of a prompt that it can process (e.g., in terms of a number of textual characters), and thus is may not be possible to use each of the foregoing as part of a prompt. Thus, embodiments classify different portions of text as wish items or wishes to for use in constructing a prompt for a code language model, and a list of wishes is referred to as a wishlist. A particular prompt is then constructed from this wishlist. In some embodiments, a wish can depend on one or more other wishes, e.g., source code line 2 before the cursor depends on a source code line directly before the cursor being included. In some embodiments, a plurality of wishes can exclude each other, e.g., an inlined import and the import statement can exclude each other. In some embodiments, a plurality of wishes can follow each other, in the sense that one should be included in the prompt after the other and not before. In some embodiments, each wish can have a respective priority, and determining which wishes from the wishlist to include in a given prompt can be performed quickly, while fulfilling wishes with higher priority first.

In some embodiments, the wishlist includes portions of text before and after the cursor. The code context assembly is configured to take a portion of text after the cursor and moves the portion of text in front of the cursor. This movement aims to heuristically identify parts of the code after the cursor that could also have been in front of the cursor. For example, different methods of a class can usually be in any order. In some embodiments, the code is parsed or partially parsed as a tree. A node including the cursor or immediately preceding the cursor is identified in the tree. For every ancestor, if that ancestor is of an appropriate kind (e.g., class), the children after the cursor can be sorted to come directly before the child that contains the cursor. This allows the code language code context assembly to use functionality defined later in the code, and to write code that is consistent with the rest of the file.

In some embodiments, the wishlist includes other open files. The code context assembly is configured to add context from other open files, such as open tabs in the user's development environment (DE). The open tabs are scanned to identify snippets of code that are deemed relevant. The snippets of code can then be used to generate a comment preceding the cursor. In some embodiments, the relevancy is estimated based on text similarity with the code immediately preceding the cursor. In some embodiments, a windowed search over the open tabs is performed. In some embodiments, multiple snippets of code from multiple open tabs are identified and inserted as comments at the cursor.

In some embodiments, the wishlist further includes metadata associated with the code file that is currently being edited. In some embodiments, the code context assembly includes a language maker configured to add a programming language as a comment. In some embodiments, the code context assembly includes a path maker configured to add a path and/or a file name as a comment. In some embodiments, these language and path makers are included in a natural way. For example, the language and path makers may be configured to add a programming language, and/or filename path as “shebang” lines (i.e., a line beginning with ‘#!’) or comments at the beginning or end of the code file. This adds valuable context, especially for short files (where sometimes the short existing code is not enough for the code context assembly to completely identify the programming language).

In some embodiments, the wishlist includes other files that are relevant to the current file. The code context assembly is configured to add context from other files, such as files stored in a same folder, or explicitly referenced, e.g., in an import statement in the code file that is currently being edited. In some embodiments, the code context assembly is configured to copy over definitions that were imported from the other files, attempting to make it seem as if those definitions were defined in the current code file that is being edited. This way, the code context assembly knows how to use important functions and APIs.

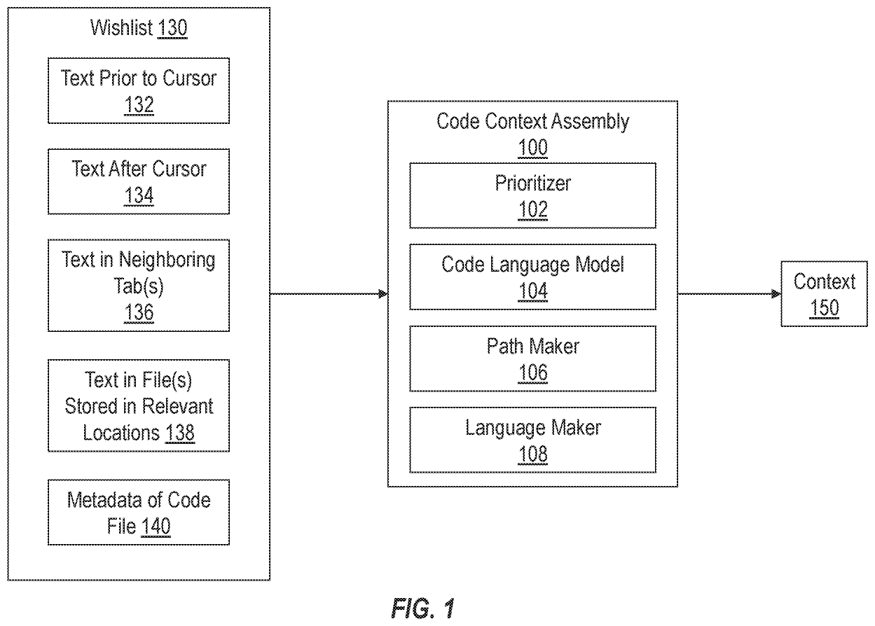

FIG. 1 illustrates an example code context assembly 100 that implements the principles described herein. The code context assembly 100 is configured to gather one or more wish items 132, 134, 136, 138, 140 on a wishlist 130, and predict context 150 based on the wishlist 130. In embodiments, the wishlist 130 includes at least one of (1) text 132 prior to a cursor that is displayed in a code editor when editing a code file, (2) text 134 after the cursor, (3) text 136 from an open tab of the editor, (4) text 138 in a second code file that is stored at a location that is relevant to the code file, and/or (5) metadata 140 associated with code file, such as (but not limited to) path information associated with where the code file is stored, and/or a programming language in which the code file is written.

In some embodiments, the code context assembly 100 includes a prioritizer 102 configured to prioritize the one or more wish items 132, 134, 136, 138, 140, and generate the context 150 based on wishlist item(s) having higher priority that other wishlist item(s). In some embodiments, each wish item has a relevant score and a weight. The prioritizer 102 is configured to rank each wish item based on the relevant score and the weight, identify a particular wishlist item that has a highest ranking, and identify one or more second portions of text from the particular wish item. In some embodiments, a wish item depends on one or more other wish items. For example, source code that is two lines before the cursor depends on source code in the line directly before the cursor being included. In some embodiments, two or more wish items exclude each other. In some embodiments, one wish item is required to follow another wish item. The prioritizer 102 is also configured to prioritize each wish item based on the dependency relationships thereamong.

In some embodiments, the code context assembly 100 further includes a language maker 108 and a path maker 106. The language maker 108 is configured to identify a programming language of the code file based on metadata associated with the code file and add context related to the programming language. The path maker 106 is configured to identify a path including a filename of the code file based on the metadata associated with the code file, and add context related to the path and/or filename of the code file.

In some embodiments, the code context assembly 100 further includes a code language model 104 configured to process the one or more wish items 132, 134, 136, 138, 140 to predict context 150. The predicted context 150 is then suggested at the cursor as code or comments. In some embodiments, the code language model 104 includes a plurality of machine-learning models that are trained based on source code, and potentially also based on natural language.

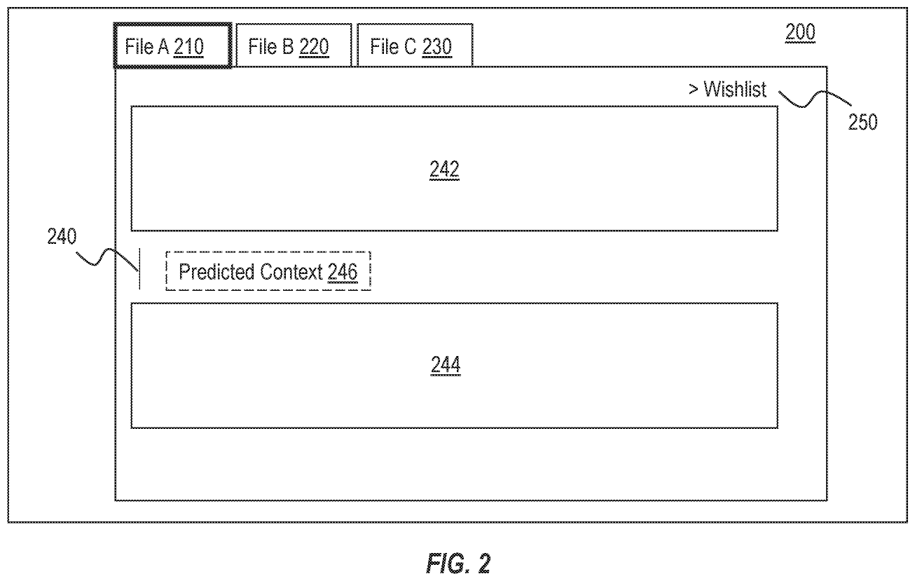

FIG. 2 illustrates an example user interface 200 of a code editor or a development environment (DE). As illustrated, multiple tabs are open in the user interface 200, namely a tab 210 for file A, a tab 220 for file B, and a tab 230 for file C. Assuming that the user is currently editing file A via tab 210, and a cursor 240 is where the user is editing. Before the cursor 240, there is a first portion of text 242 A; and after the cursor 240, there is a second portion of text 244. In some embodiments, a wishlist 250 is also displayed in the user interface 200. In some embodiments, a user is allowed to select wish items on the wishlist 250 to be considered by the code context assembly. In some embodiments, a wish item that has a highest priority is selected and shown to the user. The code context assembly is configured to predict context based on analyzing the wish items on the wishlist, and suggest or enter the predicted context 246 at the cursor 240. The predicted context 246 can include source code or comments, depending on the wish items used to generate the context.

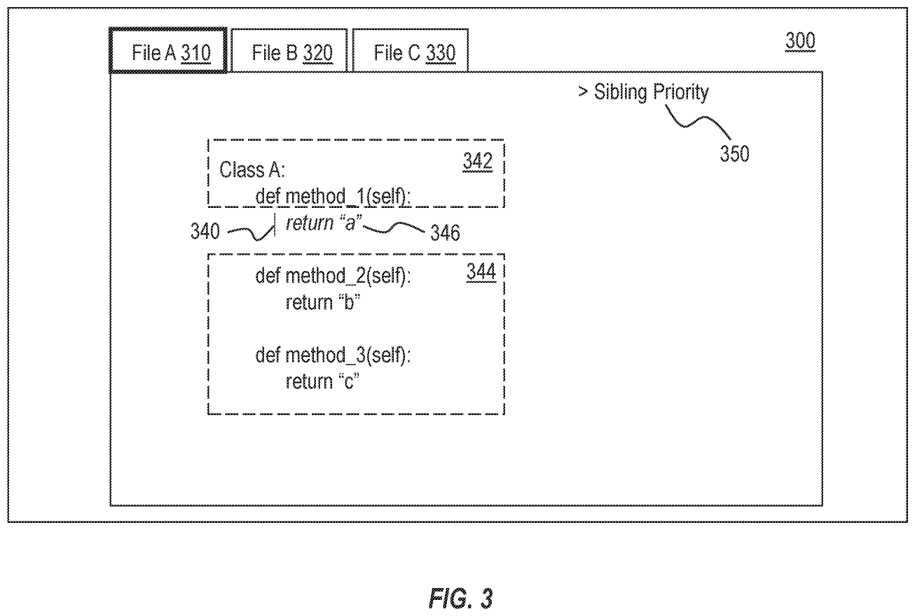

FIG. 3 illustrates another example user interface 300 of a code editor or a DE. Similar to the user interface 200 of FIG. 2, there are three tabs open in the user interface 300, namely tab 310 for file A, tab 320 for file B, and tab 330 for file C. A user is editing file A via tab 310. A cursor 340 is where the user is editing. Before the cursor 340, there is a first portion of text 342, and after the cursor 340, there is a second portion of text 344. In particular, the first portion of text 342 includes:

Class A:
def method_1(self):

The second portion of text 344 includes:
def method_2(self):
   return “b”
def method_3(self):
   return “c”

The code context assembly predicts context 346 as “return ‘a’” based on the first portion of text 342, the second portion of text 344 and their sibling relationship. In embodiments, the code context assembly identifies that sibling relationship has a highest priority, and predicted the context 346 based on the sibling relationship of the text before and after the cursor 340.

As illustrated in FIG. 3, in some embodiments, the user interface 300 also shows the wish item 350 that has the highest priority. For example, in this case, the sibling priority has the highest relationship, thus, the sibling priority is shown as the wish item 350 on the user interface 300.

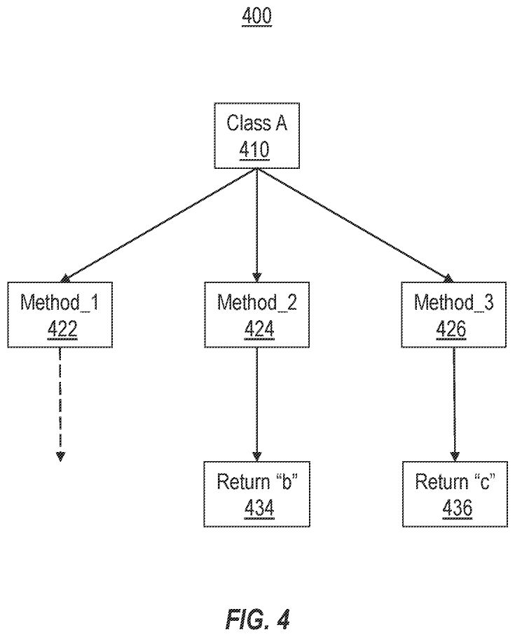

In some embodiments, identifying a sibling relationship includes parsing or partially parsing the first portion of text before the cursor and the second portion of text after the cursor to identify a tree structure. FIG. 4 illustrates an example tree structure 400 that is identified by parsing the first portion of text 342 and the second portion of text 344 of FIG. 3. As illustrated, the root of the tree structure 400 is class A 410, which has three children method_1 422, method_2 424, and method_3 426. Each of method_2 424 and method_3 426 has their respective child 434 and 436. For example, method_2 424 has a child, return “b” 434, and method_3 has a child, return “c” 436.

Once the tree structure 400 is identified, the object (i.e., method_1 422) that is currently being edited can be identified. Based on the identified object, one or more siblings of the object (i.e., method_2 424 and method_3 426) can then be identified. The siblings of the object can then be moved to the front of the object that is currently being edited.

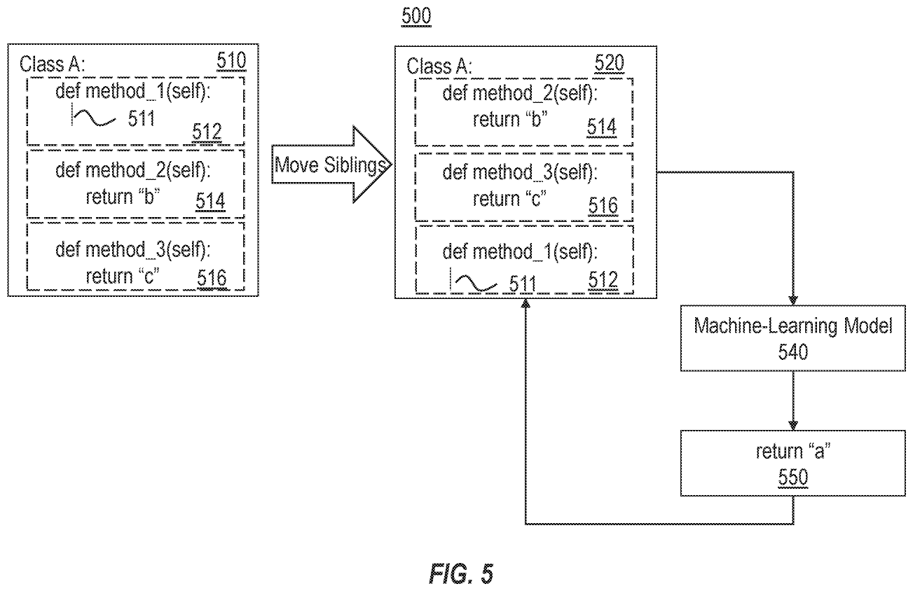

FIG. 5 illustrates an example process 500 of moving one or more siblings of objects in front of an object that is immediately preceding a cursor or including the cursor. As illustrated in FIG. 5, code 510 corresponds to the code in file A of FIG. 3. Code 510 includes objects 512, 514, and 516, which correspond to the sibling objects 422, 424, and 426 of FIG. 4. As discussed above with respect to FIGS. 3-4, the object 512, 422 is currently being edited because it is immediately before a cursor 511 or includes the cursor 511. Two objects 514, 424 and 516, 426 have been identified as siblings of object 512, 422. Thus, the two objects 514, 424 and 516, 426 are to be moved in front of the object 512, 422 to generate modified code 520.

Notably, although the movement of the objects modifies the code 510, it does not change the function of the code 510, i.e., the modified code 520 functions exactly the same as the original code 510. The modified code 520 can then be analyzed by a code language model 540 to predict context 550 that is to be entered at the cursor 511. In particular, the context 550 here is predicted as a child object of the object 512. Based on the child objects 434, 436 of the sibling objects 514, 424 and 516, 526, the child object of object 512, 422 can be predicted. Here, the child object of object 512, 422 is predicted to be “return ‘a’” based on the child objects 514, 434, and 516, 436 being “return ‘b’” and “return ‘c’”.

Note, the modified code 520 may or may not actually be used to replace the original code shown in the interface 300. In some embodiments, the modified code 520 is a separate copy of code and merely used to perform analysis, and the code 510 that the user is currently editing is not changed.

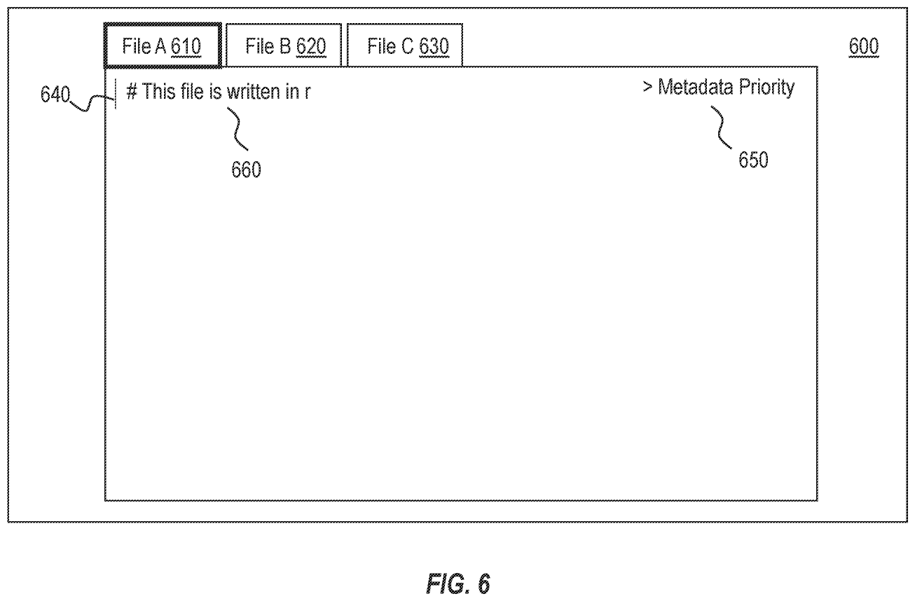

In some embodiments, the wishlist includes metadata associated with the current file that is being edited. FIG. 6 illustrates another example user interface 600 including three tabs 610, 620, 630. File A in tab 610 is currently being edited. A cursor 640 is positioned at the beginning of the file. The code context assembly is configured to use metadata associated with file A to identify a programming language that is to be used. In some embodiments, the programming language may be identified based on a file extension of a code file. For example, a file written in R has an extension “.r”, a file written in python has an extension “.py”. Here, file A has an extension “.r”; thus, the code context assembly determines that file A is written in r, and generates context 660. Here, the context 660 is a comment, stating “This file is written in r.” In some embodiments, the wish item 650 that is used to generate the context is also displayed in the user interface 600. For example, here, the context 660 is generated based on metadata, and the wish item 650 indicates “metadata priority.”

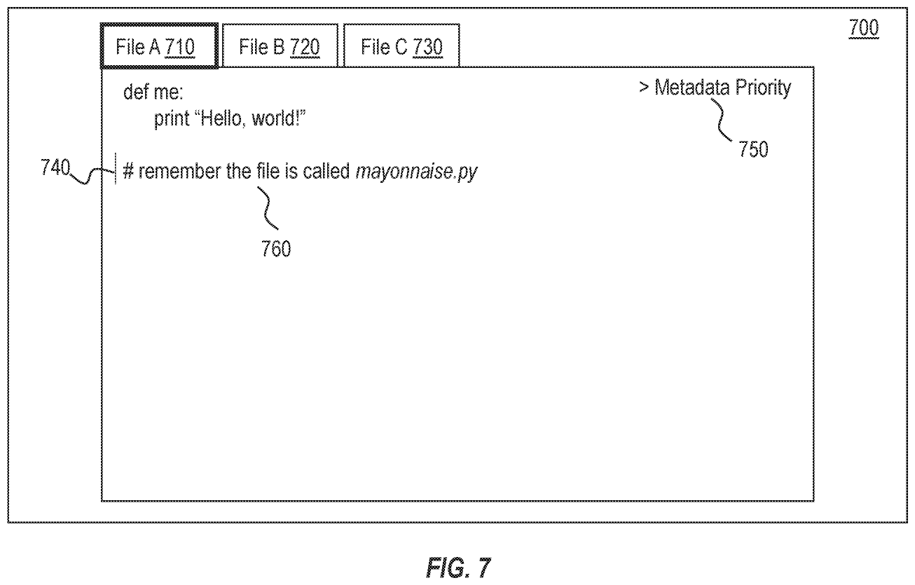

FIG. 7 illustrates another example user interface 700 including three tabs 710, 720, 730. File A in tab 710 is currently being edited. A cursor 740 is positioned at the end of the file. The code context assembly is configured to use metadata associated with file A to identify the file name of file A as “project.py” and generates context 760. Here, the context 760 is a comment, stating “remember the file is called project.py.” Again, the wish item 750 that is used to generate the context is also displayed in the user interface 700. For example, here, the context 760 is also generated based on metadata, and the wish item 750 also indicates “metadata priority.”

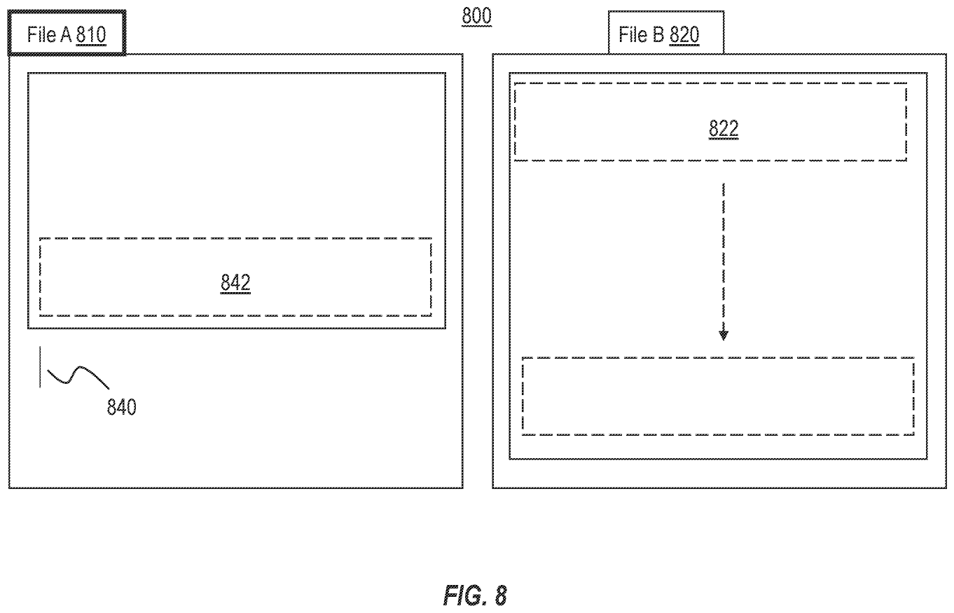

In some embodiments, the wishlist also includes open tabs. In some embodiments, the open tabs are scanned to identify snippets of code that are relevant to code immediately preceding a cursor of a current tab. FIG. 8 illustrates an example process 800 of identifying snippets of code in an open tab 820 (or another file) that are relevant to code immediately preceding a cursor of a current tab 810. As illustrated in FIG. 8, file A in tab 810 is currently being edited. A cursor 840 is where the user is currently editing. The code context assembly identifies a portion of text 842 that is immediately preceding the cursor 840. The portion of text 842 is then compared with snippets in file B of tab 820. In some embodiments, the portion of text 842 is a predetermined number of lines of code, such as (but not limited to) 5 lines, 10 lines, 20 lines, etc.

In some embodiments, a rolling window (that may or may not be the same size as the portion of text 842) is used to scan through file B of tab 820. For example, the window starts from the top of file B of tab 820 to obtain a portion of text 822 in file B of tab 820. The portion of text 822 is compared with the portion of text 842 in file A of tab 810 to compute a similarity score. Next, the window moves by a predetermined number of lines (e.g., 1 line) to obtain a next portion of text in file B of tab 820. The next portion of text is also compared with the portion of text 842 in file A of tab 810 to compute a similarity score.

For example, if the portion of text 842 is 10 lines of code immediately preceding the cursor 840, and the rolling window also is 10 lines of code, the first window of code in file B of tab 820 would be the first 10 lines of code in file B of tab 820. The first 10 lines of code in file B of tab 820 are compared with the 10 lines of code immediately preceding the cursor 840 to determine a first similarity score. Next, the window moves by a predetermined number of lines, such as 1 line. If the window moves by 1 line, the next window of code in file B of tab 820 would be lines 2-11 of code in file B. Again, the lines 2-11 of code in file B are then compared with the 10 lines of code immediately preceding the cursor 840 to determine a second similarity score. This process repeats as many times as necessary, until the whole file B is scanned. The portion of text in file B that has a highest similarity score with the portion of text 842 in file A will be identified as the most relevant snippet, and used to suggest a portion of text to be entered at the cursor 840 as code or a comment. In some embodiments, multiple snippets may be identified to be very similar to the portion of text 842 in file A, and the multiple snippets may all be used to generate one or more comments to be entered at the cursor 840.

In some cases, there may be multiple open tabs present. In some embodiments, each file in the tab is scanned to identify one or more most relevant snippet. In some embodiments, the most relevant snippet among all the open tabs is entered at the cursor as a comment. In some embodiments, the most relevant snippet in each open tab is entered as a comment.

In some embodiments, a particular open tab among the multiple open tabs is identified as the most relevant to the current file, and only the particular open tab is scanned to identify one or more most relevant snippets. In some embodiments, identifying the particular open tab includes identifying a tab that was most recently accessed by the user. In some embodiments, identifying the particular open tab includes identifying a file in a tab that is written in a same programming language or shares a same file extension. In some embodiments, each file in a tab is compared with the current file to determine a similarity score. Only the file in an open tab that has the highest similarity score is scanned to identify a snippet.

In some embodiments, the wishlist also includes other files on disk. In some embodiments, the code context assembly identifies a folder where the current file is stored, and selects one or more files from the folder to be scanned. In some embodiments, the files in the folder are first filtered based on their extension, and only the files that share the same extension as the current file are further analyzed. In some embodiments, the files that share the same extension are further compared with the current file to identify a similarity score. The similarity scores are then ranked to identify the file that is the most similar to the current file. The file that is identified as the most similar to the current file is then scanned to identify a relevant snippet.

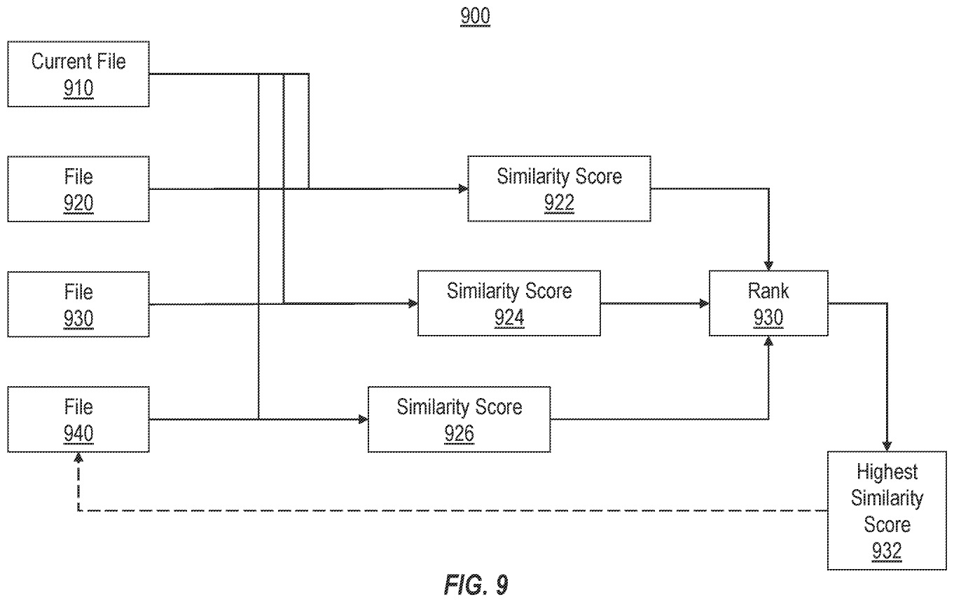

FIG. 9 illustrates an example process 900 of identifying a particular file in a plurality of files 920, 930, 940 that is the most similar to the current file 910 that is being edited. In some embodiments, the one or more files 920, 930, 940 are files stored in the same folder where the current file 910 is stored. In some embodiments, the one or more files 920, 930, 940 are files opened in a plurality of open tabs. The current file 910 is compared to each of the one or more files 920, 930, 940 to generate a similarity score 922, 924, or 926. The similarity scores 922, 924, and 926 are then ranked 930 to identify a highest similarity score 932. The file 940 that corresponds to the highest similarity score 932 can then be identified. In embodiments, the file 940 can then be scanned to identify a snippet based on the process illustrated in FIG. 8.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

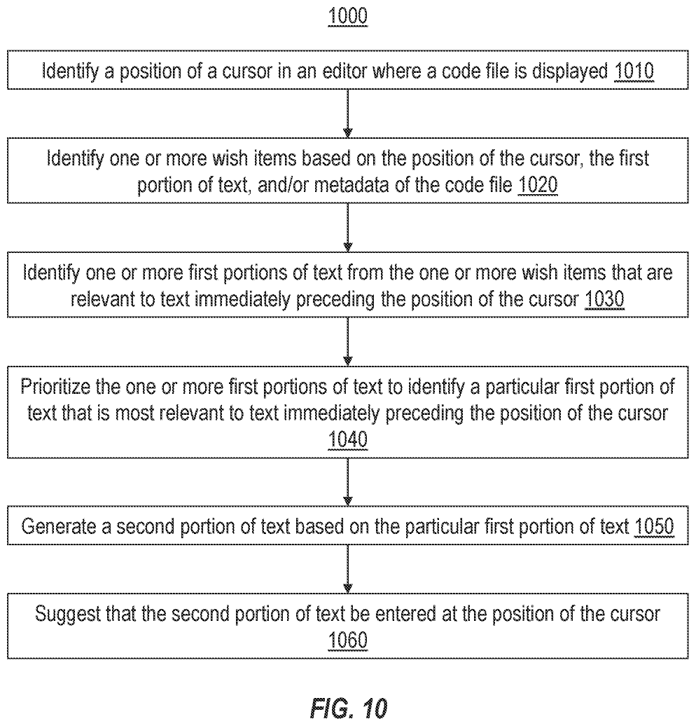

FIG. 10 illustrates a flowchart of an example method 1000 for generating context based on a wishlist of wish items. The method 1000 includes identifying a position of a cursor in an editor where a code file is displayed (act 1010). The method 1000 also includes identifying one or more wish items based on the position of the cursor, the first portion of text, and/or metadata associated with the code file (act 1020). The one or more wish items include (but are not limited to) at least one of (1) text prior to the cursor, (2) text after the cursor, (3) text from an open tab of the editor, (4) text in a second code file that is stored at a location that is relevant to the code file, or (5) metadata associated with the code file.

The method 1000 further includes identifying one or more first portions of text from the one or more wish items that are relevant to text immediately preceding the cursor (act 1030), and prioritizing the one or more second portions of text to identify a particular first portion of text that is most relevant to the first portion of text (act 1040). The method 1000 further includes generating a second portion of text based on the particular first portion of text (act 1050) and suggesting that the second portion of text be entered preceding the cursor (act 1060).

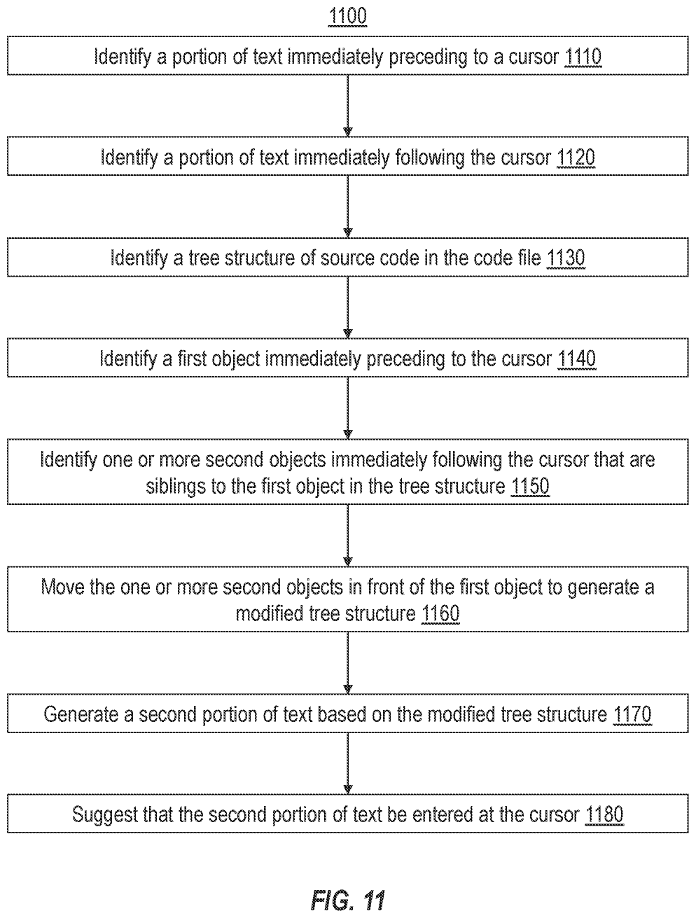

In some embodiments, the one or more wish items include text immediately preceding a cursor and text immediately following the cursor. FIG. 11 illustrates a flowchart of an example method 1100 for identifying a tree structure based on code immediately before and after the cursor and generating a second portion of text based on sibling object of an object immediately proceeding a cursor. The method 1100 includes identifying a portion of text immediately preceding the cursor (act 1110) and identifying a portion of text immediately following the cursor (act 1120). The method 1100 further includes identifying a tree structure of source code in the code file based on the portions of text immediately before and after the cursor (act 1130). Based on the tree structure, a first object immediately preceding or including the cursor (act 1140) is identified; one or more second objects immediately following the cursor that are siblings of the first object are also identified (act 1150). The method 1100 further includes moving the one or more second objects in front of the first object to generate a modified tree structure (act 1160). Finally, a second portion of text is generated based on the modified tree structure (act 1170), and the second portion of text is suggested to be entered at the cursor (act 1180). In some embodiments, the second portion of text is a child object of the first object. The child object of the first object is predicted based on a child object of the one or more second objects.

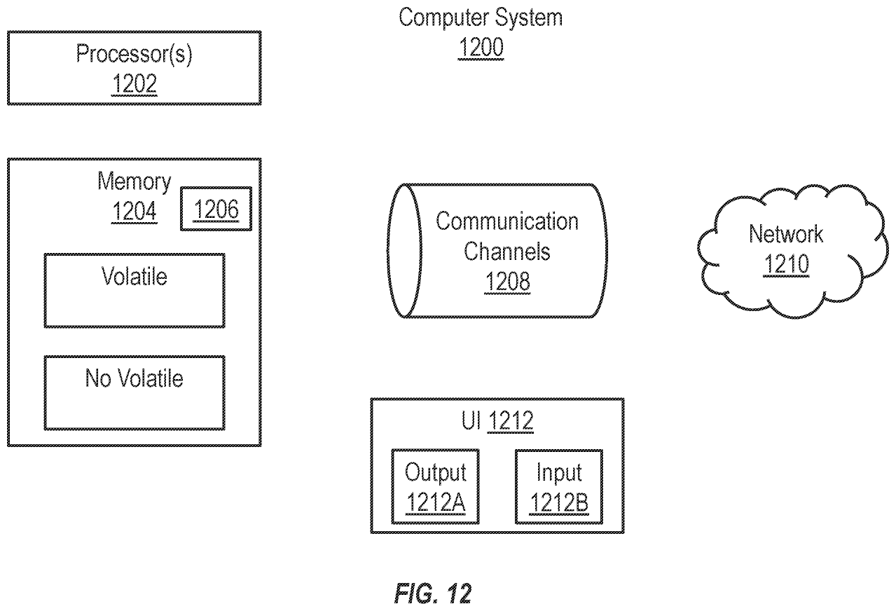

Finally, because the principles described herein may be performed in the context of a computer system (for example, the code context assembly 100 is implemented at a computer system) some introductory discussion of a computer system will be described with respect to FIG. 12.

Computer systems are now increasingly taking a wide variety of forms. Computer systems may, for example, be hand-held devices, appliances, laptop computers, desktop computers, mainframes, distributed computer systems, data centers, or even devices that have not conventionally been considered a computer system, such as wearables (e.g., glasses). In this description and in the claims, the term “computer system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computer system. A computer system may be distributed over a network environment and may include multiple constituent computer systems.

As illustrated in FIG. 12, in its most basic configuration, a computer system 1200 typically includes at least one hardware processing unit 1202 and memory 1204. The processing unit 1202 may include a general-purpose processor and may also include a field-programmable gate array (FPGA), an application-specific integrated circuit (ASIC), or any other specialized circuit. The memory 1204 may be physical system memory, which may be volatile, non-volatile, or some combination of the two. The term “memory” may also be used herein to refer to non-volatile mass storage such as physical storage media. If the computer system is distributed, the processing, memory and/or storage capability may be distributed as well.

The computer system 1200 also has thereon multiple structures often referred to as an “executable component”. For instance, memory 1204 of the computer system 1200 is illustrated as including executable component 1206. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computer system, whether such an executable component exists in the heap of a computer system, or whether the executable component exists on computer-readable storage media.

In such a case, one of ordinary skill in the art will recognize that the structure of the executable component exists on a computer-readable medium such that, when interpreted by one or more processors of a computer system (e.g., by a processor thread), the computer system is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hardcoded or hard-wired logic gates, that are implemented exclusively or near-exclusively in hardware, such as within a field-programmable gate array (FPGA), an application-specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description above, embodiments are described with reference to acts that are performed by one or more computer systems. If such acts are implemented in software, one or more processors (of the associated computer system that performs the act) direct the operation of the computer system in response to having executed computer-executable instructions that constitute an executable component. For example, such computer-executable instructions may be embodied in one or more computer-readable media that form a computer program product. An example of such an operation involves the manipulation of data. If such acts are implemented exclusively or near-exclusively in hardware, such as within an FPGA or an ASIC, the computer-executable instructions may be hardcoded or hard-wired logic gates. The computer-executable instructions (and the manipulated data) may be stored in the memory 1204 of the computer system 1200. Computer system 1200 may also contain communication channels 1208 that allow the computer system 1200 to communicate with other computer systems over, for example, network 1210.

While not all computer systems require a user interface, in some embodiments, the computer system 1200 includes a user interface system 1212 for use in interfacing with a user. The user interface system 1212 may include output mechanisms 1212A as well as input mechanisms 1212B. The principles described herein are not limited to the precise output mechanisms 1212A or input mechanisms 1212B as such will depend on the nature of the device. However, output mechanisms 1212A might include, for instance, speakers, displays, tactile output, holograms, and so forth. Examples of input mechanisms 1212B might include, for instance, microphones, touchscreens, holograms, cameras, keyboards, mouse or other pointer input, sensors of any type, and so forth.

Embodiments described herein may comprise or utilize a special purpose or general-purpose computer system, including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computer system.

A “network” is defined as one or more data links that enable the transport of electronic data between computer systems and/or modules and/or other electronic devices. When information is transferred or provided over a network or another communications connection (either hard-wired, wireless, or a combination of hard-wired or wireless) to a computer system, the computer system properly views the connection as a transmission medium. Transmissions media can include a network and/or data links that can be used to carry desired program code means in the form of computer-executable instructions or data structures and which can be accessed by a general-purpose or special-purpose computer system. Combinations of the above should also be included within the scope of computer-readable media.

Further, upon reaching various computer system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computer system RAM and/or to less volatile storage media at a computer system. Thus, it should be understood that storage media can be included in computer system components that also (or even primarily) utilize transmission media.

Computer-executable instructions comprise, for example, instructions and data which, when executed at a processor, cause a general-purpose computer system, special purpose computer system, or special purpose processing device to perform a certain function or group of functions. Alternatively or in addition, the computer-executable instructions may configure the computer system to perform a certain function or group of functions. The computer-executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, data centers, wearables (such as glasses) and the like. The invention may also be practiced in distributed system environments where local and remote computer systems, which are linked (either by hard-wired data links, wireless data links, or by a combination of hard-wired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The remaining figures may discuss various computer systems which may correspond to the computer system 1200 previously described. The computer systems of the remaining figures include various components or functional blocks that may implement the various embodiments disclosed herein, as will be explained. The various components or functional blocks may be implemented on a local computer system or may be implemented on a distributed computer system that includes elements resident in the cloud or that implement aspect of cloud computing. The various components or functional blocks may be implemented as software, hardware, or a combination of software and hardware. The computer systems of the remaining figures may include more or less than the components illustrated in the figures, and some of the components may be combined as circumstances warrant. Although not necessarily illustrated, the various components of the computer systems may access and/or utilize a processor and memory, such as processing unit 1202 and memory 1204, as needed to perform their various functions.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system comprising:
one or more processors; and
one or more computer-readable storage devices having stored thereon computer-executable instructions that are structured such that, when the computer-executable instructions are executed by the one or more processors, the computer system is configured to:
identify a position of a cursor in an editor where a code file is displayed;
identify one or more wish items based on the position of the cursor or metadata associated with the code file, the one or more wish items including at least one of (1) text data prior to the cursor, (2) text after the cursor, (3) text from one or more open tabs of the editor, (4) text in a second code file that is stored at a location that is relevant to the code file, or (5) metadata associated with the code file;
identify one or more first portions of text from the one or more wish items that are relevant to text immediately preceding the cursor;
prioritize the one or more first portions of text to identify a particular first portion of text in the one or more first portions that is most relevant to a portion of text immediately preceding the cursor;
generate a second portion of text based on the particular first portion of text; and
suggest that the second portion of text be entered preceding the cursor.

2. The computer system of claim 1, wherein generating the second portion of text is based on a code language model.

3. The computer system of claim 1, wherein:
the one or more wish items include (1) text immediately preceding the cursor, and (2) text immediately following the cursor,
the computer system is configured to:
identify a tree structure based on the text immediately preceding the cursor, and the text immediately following the cursor;
identify a first object immediately preceding the cursor;
identify one or more second objects immediately following the cursor that are siblings to the first object in the tree structure;
move the one or more second objects in front of the first object to generate a modified tree structure with the cursor at an end of the tree structure;
generate the second portion of text based on the modified tree structure; and
suggest that the second portion of text be entered at the cursor.

4. The computer system of claim 1, wherein:
the one or more wish items include text from one or more open tabs of the editor, and
the computer system is configured to:
compare the portion of text immediately preceding the cursor with a rolling window of text in the one or more open tabs of the editor to determine a similarity score, indicating a similarity between the portion of text immediately preceding the cursor and each rolling window of text;
identify a portion of text in the rolling window that has a highest similarity score with the portion of text immediately preceding the cursor; and
generate the second portion of text based on the portion of text in the rolling window that has the highest similarity score.

5. The computer system of claim 1, wherein:
the one or more wish items include text from one or more open tabs of the editor, and
the computer system is configured to:
identify a particular open tab that is most relevant to the code file;
compare the portion of text immediately preceding the cursor with a rolling window of text in the particular open tab of the editor to determine a similarity score;
identify a portion of text in the rolling window that has a highest similarity score with the portion of text immediately preceding the cursor;
suggest that the portion of text in the rolling window be entered preceding the cursor as comments.

6. The computer system of claim 5, wherein identifying the particular open tab includes:
comparing each of the one or more open tabs to identify the particular open tab that is most similar to the code file.

7. The computer system of claim 5, wherein identifying the particular open tab includes identifying the particular open tab that was most recently accessed.

8. The computer system of claim 1, wherein the metadata includes a path information associated with where the code file is stored, and the computer system is configured to:
generate the second portion of text based on a path or file name; and
enter the second portion of text preceding the cursor as comments.

9. The computer system of claim 1, wherein the metadata includes programming language in which the code file is written, and the computer system is configured to:
determine that the cursor is at top of the code file;
generate the second portion of text based on the programming language; and
enter the second portion of text preceding the cursor as comments.

10. The computer system of claim 1, wherein:
the one or more first portions of text include a portion of text in a second code file that is relevant to the code file,
the computer system is further configured to:
identify the second code file based on the portion of text prior to the cursor and a programming language in which the code file is written; and
compare a portion of text next immediately preceding the cursor with a rolling window of text in the second code file to determine a similarity score;
identify a portion of text in the second code file that has a highest similarity score with the portion of text immediately preceding the cursor; and
suggest that the portion of text be entered preceding the cursor.

11. The computer system of claim 1, wherein each wishlist item has a relevant score and a weight, and
the computer system is configured to:
rank each wish item based on the relevant score and the weight;
identify a particular wishlist item that has a highest ranking; and
identify one or more second portions of text from the particular wishlist item.

12. A method implemented at a computer system for generating context at a cursor in an editor where a code file is displayed, the method comprising:
identifying a position of a cursor in an editor where a code file is displayed;
identifying one or more wish items based on the position of the cursor or metadata associated with the code file, the one or more wish items including at least one of (1) text data prior to the cursor, (2) text after the cursor, (3) text from one or more open tabs of the editor, (4) text in a second code file that is stored at a location that is relevant to the code file, or (5) metadata associated with the code file;
identifying one or more first portions of text from the one or more wish items that are relevant to text immediately preceding the cursor;
prioritizing the one or more first portions of text to identify a particular first portion of text in the one or more first portions that is most relevant to a portion of text immediately preceding the cursor;
generating a second portion of text based on the particular first portion of text; and
suggesting that the second portion of text be entered preceding the cursor.

13. The method of claim 12, wherein generating the second portion of text is based on a code language model.

14. The method of claim 12, wherein:
the one or more first portions of text include (1) a portion of text immediately preceding the cursor, and (2) a portion of text immediately following the cursor,
the method further includes:
identifying a tree structure of source code in the code file;
identifying a first object immediately preceding the cursor;
identifying one or more second objects immediately following the cursor that are siblings to the first object in the tree structure;
moving the one or more second objects in front of the first object to generate a modified tree structure with the cursor at an end of the tree structure;
generating a second portion of text based on the modified tree structure; and
suggesting that the second portion of text be entered at the cursor.

15. The method of claim 12, wherein:
the one or more wish items include (1) text immediately preceding the cursor, and (2) text immediately following the cursor,
the method further comprising:
identifying a tree structure based on the text immediately preceding the cursor, and the text immediately following the cursor;
identifying a first object immediately preceding the cursor;
identifying one or more second objects immediately following the cursor that are siblings to the first object in the tree structure;
moving the one or more second objects in front of the first object to generate a modified tree structure with the cursor at an end of the tree structure;
generating the second portion of text based on the modified tree structure; and
suggesting that the second portion of text be entered at the cursor.

16. The method of claim 12, wherein
the one or more wish items include text from one or more open tabs of the editor, and
the method further comprising:
comparing the portion of text immediately preceding the cursor with a rolling window of text in the one or more open tabs of the editor to determine a similarity score, indicating a similarity between the portion of text immediately preceding the cursor and each rolling window of text;
identifying a portion of text in the rolling window that has a highest similarity score with the portion of text immediately preceding the cursor; and
generating the second portion of text based on the portion of text in the rolling window that has the highest similarity score.

17. The method of claim 16, wherein identifying the particular open tab includes:
comparing each of the one or more open tabs to identify the particular open tab that is most similar to the code file.

18. The method of claim 16, wherein identifying the particular open tab includes identifying the particular open tab that was accessed most recently.

19. The method of claim 12, wherein the metadata includes a path information associated with where the code file is stored, and the method further includes:
generating the second portion of text based on a path or file name; and
entering the second portion of text preceding the cursor as comments.

20. A computer program product comprising one or more hardware storage devices having stored thereon computer-executable instructions that are structured such that, when the computer-executable instructions are executed by one or more processors of a computer system, the computer-executable instructions configure the computer system to perform:
identify a position of a cursor in an editor where a code file is displayed;
identify one or more wish items based on the position of the cursor or metadata associated with the code file, the one or more wish items including at least one of (1) text data prior to the cursor, (2) text after the cursor, (3) text from one or more open tabs of the editor, (4) text in a second code file that is stored at a location that is relevant to the code file, or (5) metadata associated with the code file;
identify one or more first portions of text from the one or more wish items that are relevant to text immediately preceding the cursor;
prioritize the one or more first portions of text to identify a particular first portion of text in the one or more first portions that is most relevant to a portion of text immediately preceding the cursor;
generate a second portion of text based on the particular first portion of text; and
suggest that the second portion of text be entered preceding the cursor.
